(19) United States
(12) Patent Application Publication
(10) Pub. No.: US 2015/0185597 A1
(43) Pub. Date: Jul. 2, 2015

(54) LASER PROJECTION APPARATUS

(71) Applicants: Qisda Optronics (Suzhou) Co., Ltd., Suzhou (CN); Qisda Corporation, Taoyuan (TW)

(72) Inventors: CHIA-MING CHANG, Taichung City (TW); CHING-SHUAI HUANG, Puxin Township (TW)

(21) Appl. No.: 14/580,226

(22) Filed: Dec. 23, 2014

(30) Foreign Application Priority Data
Dec. 26, 2013 (TW) 102148481

(51) Int. Cl. G03B 21/20

(52) U.S. Cl. CPC G03B 21/2033; G03B 21/2073; G03B 21/2066

(57) ABSTRACT

A laser projection apparatus includes a first light mixing module and a light splitting module. The first light mixing module includes a plurality of first laser light sources, second laser light sources and a first dichroic mirror. The first and second laser light sources respectively emit first and second polarization lights; wherein the first and second polarization lights have different polarizations. The first dichroic mirror, disposed between the first and second laser light sources, includes first and second surfaces respectively toward the first and second laser light sources. The first surface reflects the first polarization light. The second polarization light sequentially passes through the second and first surfaces to mix with the first polarization light and thereby forming a first laser beam. The light splitting module is for receiving the first laser beam and splitting the first laser beam into a plurality of color lights.

### FIELD OF THE INVENTION

The present invention relates to a laser projection apparatus, and more particularly to a laser projection apparatus which uses a dichroic mirror capable of reflecting a first polarization light and allowing a second polarization light, having a polarization different with the first polarization light, to pass therethrough, and the first and second polarization lights are then mixed with each other thereby forming a laser beam.

### BACKGROUND OF THE INVENTION

Basically, general laser projection apparatus uses a light mixing module and a light splitting module to corporately form a plurality of color lights for image projection. Please refer to FIG. 1, which is a schematic structural view of a conventional laser projection apparatus. As shown in FIG. 1, the conventional laser projection apparatus 10 includes a light mixing module 12, a light guiding module 14 and a light splitting module 16. The light mixing module 12 includes a plurality of reflective mirrors 18, a plurality of first laser light sources 20 and a plurality of second laser light sources 22. The light guiding module 14 includes a convex lens 24, a reflective mirror 26 and a concave lens 28.

As shown in FIG. 1, the reflective mirrors 18 are spaced with regular intervals and tilted relative to the first and second laser light sources 20 and 22. The first laser light sources 20 are disposed to aim at the reflective mirrors 18, respectively. The second laser light sources 22 and the reflective mirrors 18 have an interlacing arrangement relative to the convex lens 24. The light emitted from the first laser light sources 20 can be reflected by the reflective mirrors 18; and the light emitted from the second laser light sources 22 can pass through the intervals between the reflective mirrors 18. Then, the light emitted from the first laser light sources 20 and reflected by the reflective mirrors 18 and the light emitted from the second laser light sources 22 and passing through the intervals are mixed with each other thereby forming a laser beam. The laser beam is then emitted to the convex lens 24. Thus, after sequentially passing through the convex lens 24, being reflected by the reflective mirror 26 and passing through the concave lens 28, the laser beam formed by the first and second laser light sources 20 and 22 is reduced to a specific size by the light guiding module 14 and is able to be received by the light splitting module 16.

Then, the light splitting module 16 splits the laser beam into a plurality of color lights (such as red, blue and green lights) for the following image projection. To get a better understanding of the conventional laser projection apparatus 10 of FIG. 1, the following description is based on that both of the first and second laser light sources 20 and 22 are blue laser light sources and accordingly the laser beam produced by the light mixing module 12 and the light guiding module 14 is a blue laser beam. As shown in FIG. 1, the light splitting module 16 includes a dichroic mirror 30, a phosphor color wheel 32 and a plurality of reflective mirrors 34. When the blue laser beam emits to the dichroic mirror 30, the dichroic mirror 30 allows the blue laser beam to pass therethrough and then the blue laser beam emits to the phosphor color wheel 32. Thus, the phosphor powder on the phosphor color wheel 32 is activated by the blue laser beam and generates lights with colors different from the blue light (such as red and green lights, which are referred to as “non-blue” lights herein below). Then, the generated non-blue lights are reflected back to the dichroic mirror 30. Moreover, a portion of the blue laser beam capable of passing through the phosphor color wheel 32 is reflected by the reflective mirrors 34 sequentially and then is emitted to the dichroic mirror 30 again. As a result, after the blue laser beam has passed through the dichroic mirror 30 twice and the above-mentioned non-blue light has been reflected by the dichroic mirror 30, the light splitting module 16 splits the blue laser beam into a plurality of color lights for the following image projection.

However, according to the aforementioned description, it is to be noted that the reflective mirrors 18 are required to be spaced with regular intervals, the first laser light sources 20 aims at the reflective mirrors 18, respectively, and the second laser light sources 22 and the reflective mirrors 18 are disposed to have an interlacing arrangement. Thus, the light mixing module 12 may not have a compact size and consequentially the conventional laser projection apparatus 10 may not have a miniaturization design due to the presence or existence of the intervals between the adjacent two reflective mirrors 18, the adjacent two first laser light sources 20 and the adjacent two second laser light sources 22.

### SUMMARY OF THE INVENTION

Therefore, one object of the present invention is to provide a laser projection apparatus adopting a dichroic mirror capable of reflecting a first polarization light and allowing a second polarization light different from the first polarization light to pass therethrough. The first and second polarization lights are then mixed with each other thereby forming a laser beam. Thus, the laser projection apparatus of the present invention has compact size.

The present invention provides a laser projection apparatus, which includes a first light mixing module and a light splitting module. The first light mixing module includes a plurality of first laser light sources, a plurality of second laser light sources and a first dichroic mirror. The first laser light sources emit a first polarization light, respectively. The second laser light sources emit a second polarization light, respectively, wherein the first polarization light is different from the second polarization light. The first dichroic mirror is disposed between the first and second laser light sources. The first dichroic mirror includes a first surface toward each one of the first laser light sources and a second surface toward each one of the second laser light sources. The first surface reflects the first polarization light. The second polarization light sequentially passes through the second surface and the first surface to mix with the first polarization light and thereby forming a first laser beam. The light splitting module receives the first laser beam and splits the first laser beam into a plurality of color lights.

In summary, the laser projection apparatus of the present invention adopts a dichroic mirror capable of reflecting the first polarization light and allowing the second polarization light (having a polarization different with the first polarization light) to pass therethrough. The first and second polarization lights are then mixed with each other thereby forming a laser beam, and the laser bean is then emitted into the light splitting module for light splitting. As a result, compared with the conventional laser projection apparatus using reflective mirrors having specific intervals therebetween, the dimensions of the dichroic mirror and light mixing module are reduced; and consequentially, the laser projection apparatus of the present invention has compact size and miniaturization design.

For making the above and other purposes, features and benefits become more readily apparent to those ordinarily skilled in the art, the preferred embodiments and the detailed descriptions with accompanying drawings will be put forward in the following descriptions.

### BRIEF DESCRIPTION OF THE DRAWINGS

The present invention will become more readily apparent to those ordinarily skilled in the art after reviewing the following detailed description and accompanying drawings, in which:

FIG. 1 is a schematic structural view of a conventional laser projection apparatus;

FIG. 2 is a schematic structural view of a laser projection apparatus in accordance with a first embodiment of the present invention; and

FIG. 3 is a schematic structural view of a laser projection apparatus in accordance with a second embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

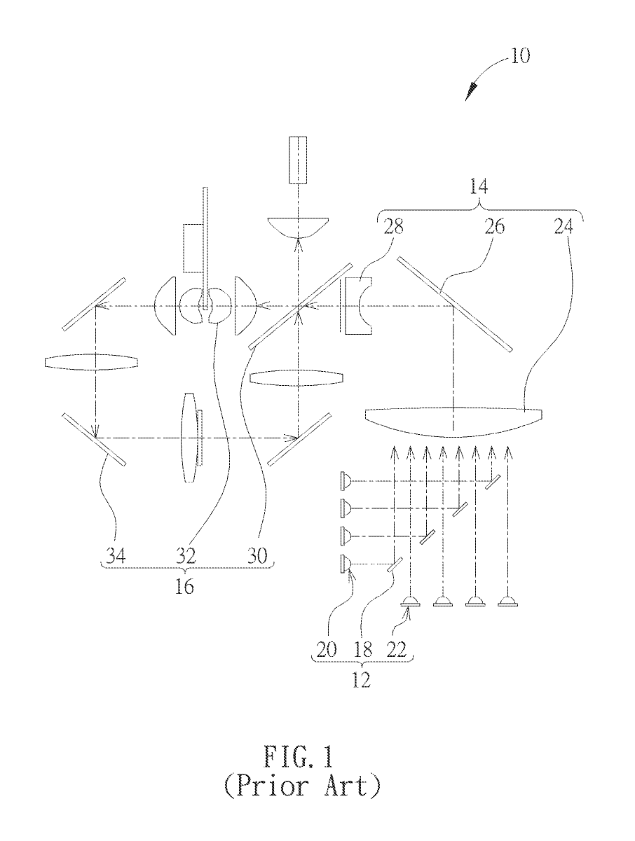

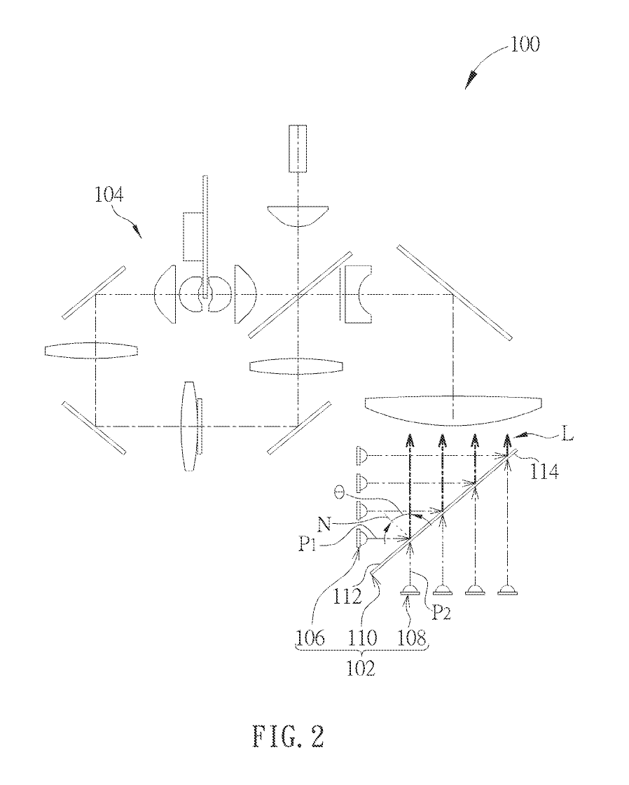

Please refer to FIG. 2, which is a schematic structural view of a laser projection apparatus 100 in accordance with a first embodiment of the present invention. As shown in FIG. 2, the laser projection apparatus 100 in the present embodiment includes a light mixing module 102 and a light splitting module 104. The light splitting module 104 is adjacent to the light mixing module 102, and is used for receiving the laser beam produced by the light mixing module 102 and splitting the received laser beam into a plurality color lights (such as red, blue and green lights) which the laser projection apparatus 100 requires for the following image projection. Similar to the conventional light splitting module 16 of FIG. 1, the light splitting module 104 also includes a dichroic mirror, a phosphor color wheel and a plurality of reflective mirrors. Because the component configuration of the light splitting module has been described previously, no any redundant detail to be given herein. The light mixing module 102 includes a plurality of first laser light sources 106, a plurality of second laser light sources 108 and a dichroic mirror 110. The other components in the laser projection apparatus 100 (such as the light guiding module, the imaging module and the projecting module) are well known to those ordinarily skilled in the art, thus, no any redundant detail is to be given herein.

The first laser light sources 106 are spaced with intervals, and each first laser light sources 106 emits a first polarization light P₁. The second laser light sources 108, disposed next to the first laser light sources 106, are spaced with intervals, and each of the second laser light sources 108 emits a second polarization light P₂. In one embodiment, preferably, both of the first laser light sources 106 and the second laser light sources 108 are Blu-ray laser diodes; however, it is understood that the first laser light sources 106 and the second laser light sources 108 may have other types of implementations according to the practical application of the laser projection apparatus 100. The first polarization light P₁ and the second polarization light P₂ may be any general polarization light and the two polarization lights have different polarizations. In one embodiment, for example, the first polarization light P₁ is S-polarization light, and the second polarization light P₂ is P-polarization light; however, the present invention is not limited thereto. It should be noted that the quantity and the arrangement of the first and second laser light sources 106 and 108 illustrated in FIG. 2 are used for an exemplary purpose only. Specifically, the light mixing module 102 is not limited to have four first laser light sources 106 and four second laser light sources 108, and the first laser light sources 106 and the second laser light sources 108 are not limited to have one-to-one arrangement manner. Furthermore, the amount of the first laser light sources 106 may differ from that of the second laser light sources 108, which depends upon a practical application of the laser projection apparatus 100.

The dichroic mirror 110 is disposed between the first and second light sources 106 and 108 and is tilted relative to the first and second light sources 106 and 108. The dichroic mirror 110 is an optical element capable of reflecting the first polarization light P₁ and allowing the second polarization light P₂ having a polarization different with that of the first polarization light P₁ to pass therethrough. The dichroic mirror 110 has a first surface 112 toward each one of the first laser light sources 106 and a second surface 114 toward each one of the second laser light sources 108. Moreover, the first surface 112 reflects the first polarization light P₁ emitted from the first laser light sources 106. The second polarization light P₂ emitted from the second laser light sources 108 sequentially passes through the second surface 114 and the first surface 112 of the dichroic mirror 110, and consequentially is mixed with the first polarization light P₁ thereby forming a laser beam L. In one embodiment, preferably, the angle θ formed between the normal line N of the dichroic mirror 110 and the laser beam L is about 40 degrees to 50 degrees; however, the present invention is not limited thereto.

The process of the laser projection apparatus 100 producing the laser beam L will be described as follow. In the following exemplary process, a configuration of the first polarization light P₁ being S-polarization light, the second polarization light P₂ being P-polarization light and the dichroic mirror 110 being for reflecting S-polarization light and allowing P-polarization light to pass therethrough is taken as an example; however, the present invention is not limited thereto. In other words, the first polarization light P₁ may be P-polarization light, the second polarization light P₂ may be S-polarization light in an another embodiment, and accordingly the dichroic mirror 110 is for reflecting P-polarization light and allowing S-polarization light to pass therethrough in the another embodiment.

As shown in FIG. 2, when the first and second polarization lights P₁ and P₂ emitting to the dichroic mirror 110, the first polarization light P₁ is reflected by the dichroic mirror 110 and the second polarization light P₂ passes through the dichroic mirror 110 directly. Then, the second polarization light P₂ passing through the dichroic mirror 110 and the first polarization light P₁ reflected by the dichroic mirror 110 are mixed with each other thereby corporately forming the laser beam L (e.g., a Blu-ray laser beam). And then, the light splitting module 104 receives the laser beam L and splits the received laser beam L into a plurality of color lights (such as red, blue and green lights) for the laser projection apparatus 100 to perform the following image projection. Because the splitting mechanism (or method of light splitting operation) of the light splitting module 104 has been described previously and is well known to those ordinarily skilled in the art, no any redundant detail is to be given herein.

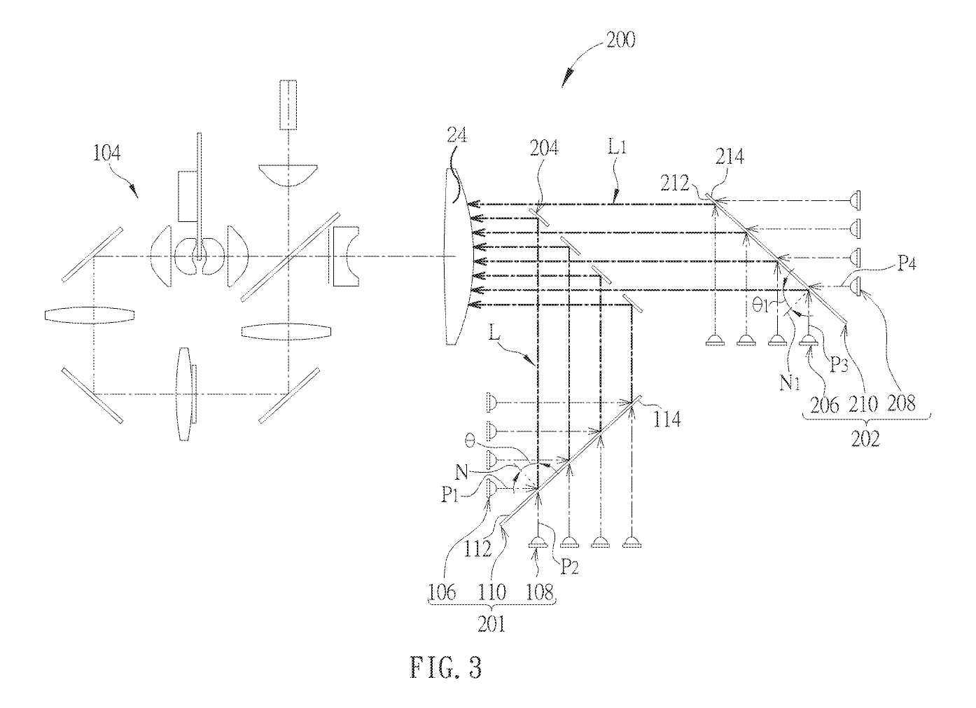

It is to be noted that the brightness of the laser beam produced by the light mixing module in the laser projection apparatus can be further enhanced by employing more than one light mixing module. Please refer to FIG. 3, which is a schematic structural view of a laser projection apparatus in accordance with a second embodiment of the present invention. It is to be noted that the same label number in FIGS. 2 and 3 represent the same component having similar functions or structures. As shown in FIG. 3, the laser projection apparatus 200 in the present embodiment includes a light splitting module 104, a first light mixing module 201, a second light mixing module 202 and a plurality of reflective mirrors 204. The first light mixing module 201 includes a plurality of first laser light sources 106, a plurality of second laser light sources 108 and a dichroic mirror 110. Because the first light mixing module 201 has a structure similar to that of the light mixing module 102 in FIG. 2, no any redundant detail is to be given herein.

The second light mixing module 202 is disposed adjacent to the first light mixing module 201, and includes a plurality of third laser light sources 206, a plurality of fourth laser light sources 208 and a dichroic mirror 210. The third laser light sources 206 are spaced with intervals, and each of the third laser light sources 206 emits a third polarization light P₃. The fourth laser light sources 208, disposed adjacent to the third laser light sources 206, are spaced with intervals, and each of the fourth laser light sources 208 emits a fourth polarization light P₄. In one embodiment, preferably, both of the third laser light sources 206 and the fourth laser light sources 208 are Blu-ray laser diodes; however, it is understood that the third laser light sources 206 and the fourth laser light sources 208 may have other types of implementations according to the practical application of the laser projection apparatus 200. The third polarization light P₃ and the fourth polarization light P₄ may be any commonly-known polarization light with different polarizations. In one embodiment, for example, the third polarization light P₃ is S-polarization light and correspondingly the fourth polarization light P₄ is P-polarization light; however, the present inv limited thereto. It should be noted that the quantity and the arrangement of the third and fourth laser light sources 206 and 208 illustrated in FIG. 3 are used for an exemplary purpose only. Furthermore, the amount of the third laser light sources 206 may differ from that of the fourth laser light sources 208, which depends upon a practical application of the laser projection apparatus 200.

The dichroic mirror 210 is disposed between the third and fourth laser light sources 206 and 208 and is tilted relative to the third and fourth laser light sources 206 and 208. The dichroic mirror 210 is an optical element capable of reflecting the third polarization light P₃ and allowing the light having a polarization different with that of the third polarization light P₃ (that is, the fourth polarization light P₄) to pass therethrough. The dichroic mirror 210 has a third surface 212 toward each one of the third laser light sources 206 and a fourth surface 214 toward each one of the forth laser light sources 208. Moreover, the third surface 212 reflects the third polarization light P₃ emitted from the third laser light sources 206. The fourth polarization light P₄ emits from the fourth laser light sources 208 sequentially passes through the fourth surface 214 and the third surface 212 of the dichroic mirror 210 consequentially, and is mixed with the third polarization light P₃ thereby forming a laser beam L₁. In one embodiment, preferably, the angle θ₁ formed between the normal line N₁ of the dichroic mirror 210 and the laser beam L₁ is about 40 degrees to 50 degrees, and the reflective mirrors 204 are disposed parallel to the dichroic mirror 210; however, the present invention is not limited thereto.

As shown in FIG. 3, the reflective mirrors 204 are spaced with intervals. Specifically, the reflective mirrors 204 are disposed between and tilted relative to the first and second light mixing modules 201 and 202. The reflective mirrors 204 aim to the second laser light sources 108 respectively, and each of the reflective mirrors 204 is for reflecting the laser beam L, which is formed by a mix of the first polarization light P₁ emitted from the first laser light sources 106 and the second polarization light P₂ emitted from the second laser light sources 108. Then, the laser beam L emits into the light splitting module 104. The fourth laser light sources 208 and the reflective mirrors 204 are staggered relative to the convex lens 24. Thus, the fourth polarization light P₄ emitted from the fourth laser light sources 208 and the third polarization light P₃ emitted from the third laser light sources 206 can be mixed with each other to form the laser beam L₁. The laser beam L₁ then emits into the light splitting module 104.

The process of the laser projection apparatus 200 producing the laser beam will be described as follow. In the following exemplary process, a configuration of the first and third polarization lights P₁ and P₃ being S-polarization light, the second and fourth polarization lights P₂ and P₄ being P-polarization light and the dichroic mirrors 110, 210 being for reflecting S-polarization light and allowing P-polarization light to pass therethrough is taken as an example; however, the present invention is not limited thereto. In other words, the first and third polarization lights P₁ and P₃ may be P-polarization light, the second and fourth polarization lights P₂ and P₄ may be S-polarization light in an another embodiment, and accordingly the dichroic mirrors 110, 210 are for reflecting P-polarization light and allowing S-polarization light to pass therethrough in the another embodiment. Or, in still another embodiment, the first and fourth polarization lights P₁ and P₄ may be P-polarization light, the second and third polarization lights P₂ and P₃ may be S-polarization light, the dichroic mirror 110 is for reflecting P-polarization light and allowing S-polarization light to pass therethrough, and the dichroic mirror 210 is for reflecting S-polarization light and allowing P-polarization light to pass therethrough.

As shown in FIG. 3, when the first and second polarization lights P₁ and P₂ are emitting to the dichroic mirror 110, the first polarization light P₁ is reflected by the dichroic mirror 110 and the second polarization light P₂ passes through the dichroic mirror 110 directly. Then, the second polarization light P₂ passing through the dichroic mirror 110 is mixed with the first polarization light P₁ reflected by the dichroic mirror 110 thereby corporately forming the laser beam L (e.g., a Blu-ray laser beam). Similarly, when the third and fourth polarization lights P₃ and P₄ are emitting to the dichroic mirror 210, the third polarization light P₃ is reflected by the dichroic mirror 210 and the fourth polarization light P₄ passes through the dichroic mirror 210 directly. Then, the fourth polarization light P₄ passing through the dichroic mirror 210 is mixed with the third polarization light P₃ reflected by the dichroic mirror 210 thereby corporately forming the laser beam L₁ (e.g., a Blu-ray laser beam).

Then, as shown in FIG. 3, the reflective mirrors 204 can reflect the laser beam L into the light splitting module 104 without blocking the laser beam L₁ to emit into the light splitting module 104; wherein the laser beam L₁ may pass through the intervals between the reflective mirrors 204. Then, when receiving the laser beam L produced by the first light mixing module 201 and the laser beam L₁ produced by the second light mixing module 202, the light splitting module 104 splits the laser beams L and L₁ into a plurality of color lights (such as red, blue and green lights) for the laser projection apparatus 200 to perform the following image projection. As a result, the overall brightness of the laser beam is enhanced by using two light mixing modules. Because the splitting mechanism of the light splitting module 104 has been described previously and is well known to those ordinarily skilled in the art, no any redundant detail is to be given herein.

In summary, the laser projection apparatus of the present invention adopts a dichroic mirror capable of reflecting the first polarization light and allowing the second polarization light (having a polarization different with the first polarization light) to pass therethrough. The first and second polarization lights are then mixed with each other thereby forming a laser beam, and the laser bean is then emitted into the light splitting module for light splitting. As a result, compared with the conventional laser projection apparatus using reflective mirrors having specific intervals therebetween, the dimensions of the dichroic mirror and light mixing module are reduced; and consequentially, the laser projection apparatus of the present invention has a more compact size and improved miniaturization design.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A laser projection apparatus, comprising:
a first light mixing module, comprising:
a plurality of first laser light sources, the first laser light sources emitting a first polarization light, respectively;
a plurality of second laser light sources, the second laser light sources emitting a second polarization light, respectively, wherein the first polarization light is different from the second polarization light; and
a first dichroic mirror disposed between the first and second laser light sources, the first dichroic mirror comprising:
a first surface toward each one of the first laser light sources; and
a second surface toward each one of the second laser light sources, wherein the first surface reflects the first polarization light, and the second polarization light sequentially passes through the second surface and the first surface of the first dichroic mirror to mix with the first polarization light and thereby forming a first laser beam; and
a light splitting module, receiving the first laser beam and splitting the first laser beam into a plurality of color lights.

2. The laser projection apparatus according to claim 1, wherein each one of the first and second laser light sources is a Blu-ray laser diode.

3. The laser projection apparatus according to claim 1, wherein the first polarization light is a P-polarization light or a S-polarization light.

4. The laser projection apparatus according to claim 1, wherein an angle from 45 degrees to 50 degrees is formed between a normal line direction of the first dichroic mirror and the first laser beam.

5. The laser projection apparatus according to claim 1, further comprising:
a second light mixing module, comprising:
a plurality of third laser light sources, the third laser light sources emitting a third polarization light, respectively;
a plurality of fourth laser light sources, the fourth laser light sources emitting a fourth polarization light, respectively, wherein the third polarization light is different from the fourth polarization light; and
a second dichroic mirror disposed between the third and fourth laser light sources, the second dichroic mirror comprising:
a third surface toward each one of the third laser light sources; and
a fourth surface toward each one of the fourth laser light sources, wherein the third surface reflects the third polarization light, and the fourth polarization light sequentially passes through the fourth surface and the third surface of the second dichroic mirror to mix with the third polarization light and thereby forming a second laser beam; and
a plurality of reflective mirrors disposed between the first and second light mixing modules, wherein the reflective mirrors aim to the second laser light sources respectively so as to reflect the first laser beam into the light splitting module, and the fourth laser light sources and the reflective mirrors have an interlacing arrangement thereby emitting the second laser beam into the light splitting module, wherein the light splitting module further receives the second laser beam and splits the second laser beam into a plurality of color lights.

6. The laser projection apparatus according to claim 5, wherein each one of the first, second, third and fourth laser light sources is a Blu-ray laser diode.

7. The laser projection apparatus according to claim 5, wherein the first polarization light is a P-polarization light or a S-polarization light.

8. The laser projection apparatus according to claim 7, wherein the third polarization light is a P-polarization light or a S-polarization light.

9. The laser projection apparatus according to claim 5, wherein an angle from 45 degrees to 50 degrees is formed between a normal line direction of the first dichroic mirror and the first laser beam, and an angle from 45 degrees to 50 degrees is formed between a normal line direction of the second dichroic mirror and the second laser beam.

10. The laser projection apparatus according to claim 9, wherein the reflective mirrors are disposed parallel to the second dichroic mirror.
